(19) United States
(12) Patent Application Publication
(10) Pub. No.: US 2009/0287781 A1
(43) Pub. Date: Nov. 19, 2009

(54) GROUPING MESSAGES USING PATTERNS IN A MESSAGING SYSTEM

(75) Inventor: William Lee Newcomb, JR., Queen Creek, AZ (US)

Correspondence Address: DUKE W. YEE, YEE AND ASSOCIATES, P.C., P.O. BOX 802333, DALLAS, TX, 75380, US

(73) Assignee: International Business Machines Corporation, Armonk, NY (US)

(21) Appl. No.: 12/123,175

(22) Filed: May 19, 2008

(51) Int. Cl. G06F 15/16

(52) U.S. Cl. 709/206

(57) ABSTRACT

A computer implemented method, apparatus, and computer usable program code for handling messages. A plurality of messages that have failed to be sent to a set of destination applications is identified. The plurality of messages is grouped based on a pair of associated identifiers in headers for the plurality of messages into a set of groupings. The set of groupings is sent to a set of recipients associated with the set of groupings.

### BACKGROUND OF THE INVENTION

1. Field of the Invention

The present invention relates generally to an improved data processing system and more specifically to a method and apparatus for messaging across multiple environments. Still more particularly, the present invention relates to a computer implemented method, apparatus, and computer usable program code for grouping messages in a network data processing system.

2. Description of the Related Art

Electronic business, also referred to as e-business, has become a common place medium for many businesses and organizations to conduct business and other transactions. With this type of business, the Internet has become a primary medium for conducting transactions. Different businesses and organizations may set up, operate, and integrate applications across multiple computing platforms through various technologies. These technologies include systems for creating web pages to send to users and customers, as well as processing various transactions that may occur.

The transfer of information between these different applications may involve sending messages. One family of products that may be used is WebSphere® software, which is available from International Business Machines Corporation. WebSphere® is a registered trademark of International Business Machines Corporation. For example, a user or customer may initiate a transaction to purchase an item at a web browser. The user may identify an item and enter credit card information. This information is sent as a message to a business application for processing. As another example, another user at a web browser may search for reservation information or flights at an airline. These queries are also sent as messages to a business application. The responses to these transactions are returned in messages.

With this type of environment, messages may be sent to a central hub for transformation and routing to various server applications. Transformations may be performed to convert the message from a format used by the application generating the message into a format that may be used by the particular application receiving the message. In some cases, a message may fail to be transformed and/or routed to an application. This failure may occur for different reasons. For example, the data content or a parsing exception may cause the message to be put into a failure queue with the failure being placed into a log.

In this type of environment, millions of messages may be processed every day by a business or other organization. With these numbers of messages, potentially thousands of messages may fail to be transformed and/or routed to a destination application. It is desirable to send these messages back to some person, team, or other group that supports the application that generated the message. By obtaining the failed messages, an analysis may be made to identify and potentially fix the application to reduce or eliminate the generation of messages that may fail to be routed to the proper destination.

Currently, a technician or other human operator examines the failed messages that have been placed into a failure queue. This person also may examine the error text in the log. From this examination, the operator may identify the group supporting the message and send an electronic mail message to the group with the information regarding the failed messages. This type of process is a manually intensive process as well as costly. With this current system, an operator is required to set aside many hours each day to perform this activity instead of performing other duties.

Therefore, it would be advantageous to have an improved computer implemented method, apparatus, and computer usable program code that overcomes the problems described above.

### BRIEF SUMMARY OF THE INVENTION

The illustrative embodiments provide a computer implemented method, apparatus, and computer usable program code for handling messages. A plurality of messages that have failed to be sent to a set of destination applications is identified. The plurality of messages is grouped based on a pair of associated identifiers in headers for the plurality of messages into a set of groupings. The set of groupings is sent to a set of recipients associated with the set of groupings.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is a block diagram of a data processing system in which illustrative embodiments may be implemented;

FIG. 3 is a diagram illustrating an entry in a message table in accordance with an illustrated embodiment;

FIG. 4 is a flowchart of a process for grouping messages in accordance with an illustrative embodiment;

FIG. 5 is a flowchart of a process for grouping messages in accordance with an illustrative embodiment; and

FIG. 6 is a flowchart of a process for sending groups of messages to recipients in accordance with an illustrative embodiment.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

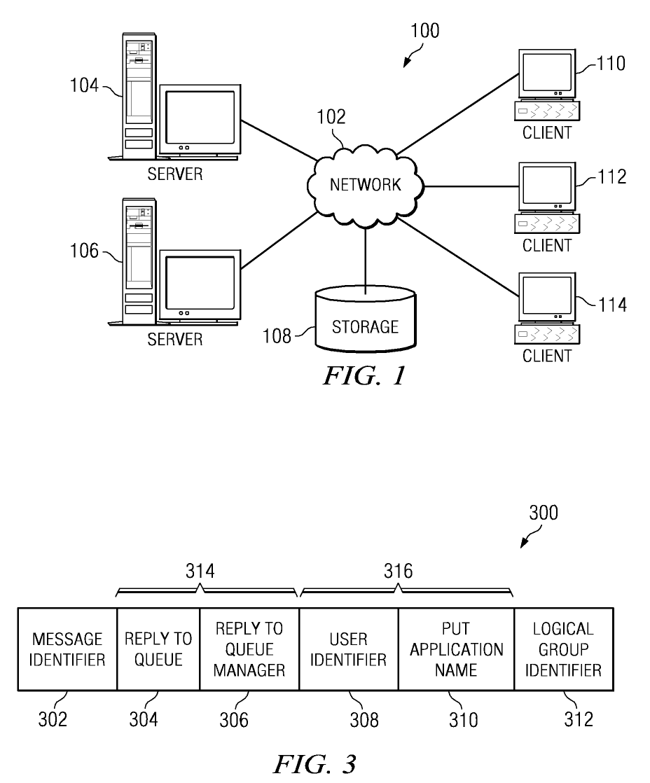

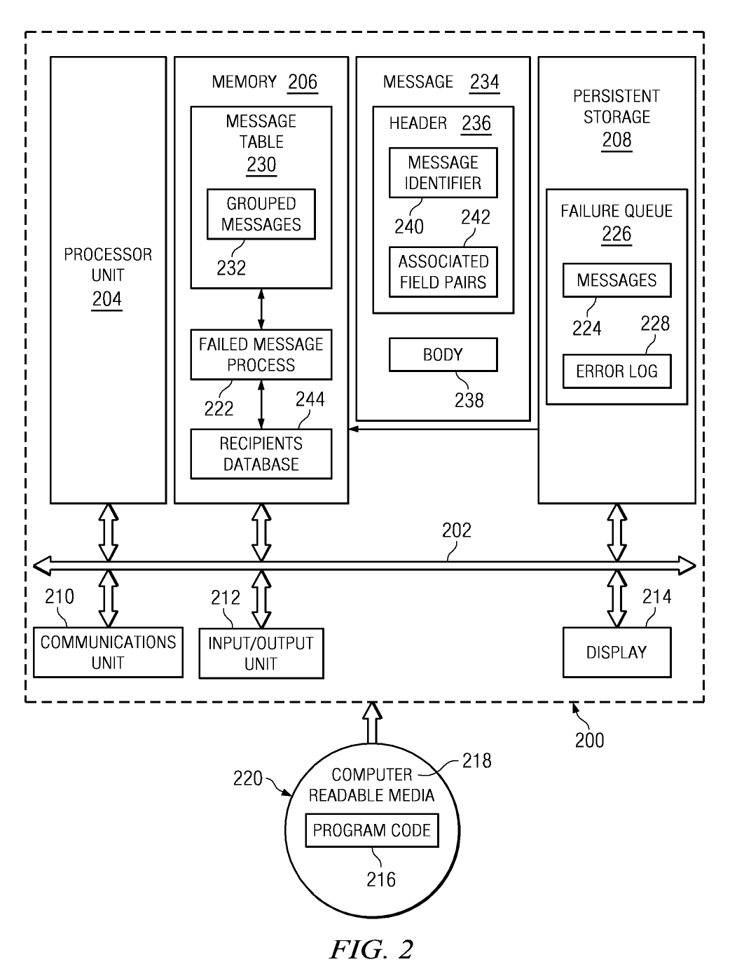

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers and/or network computers. In the depicted example, server 104 provides data, such as boot files, operating system images, and applications to clients 110, 112, and 114. Clients 110, 112, and 114 are clients to server 104 in this example. In these examples, server 104 and server 106 may have messaging applications used to perform transactions with clients 110, 112, and 114. One of the messaging applications may perform transformations and/or routing of messages between different applications within network data processing system 100. The different illustrative embodiments may be implemented on server 104 and/or server 106 to handle messages that may fail to be transformed and/or routed to an appropriate destination. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208.

In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

In the illustrative embodiments, program code 216 may be program code for failed message process 222 in memory 206. Failed message process 222 may process messages 224 in failure queue 226. Messages 224 in failure queue 226 are messages that have failed to have been sent to a destination. Messages 224 may have failed for various reasons, such as, for example, data content or a parsing exception in the message. In other words, one or more of messages 224 may have failed to have been transformed from a format from the application generating the message into the format for the application to receive the message. One or more of messages 224 may have failed to be routed to a destination for some other reason. Failure queue 226 may be a failure queue for a central hub in the messaging system in which the transformation and routing of messages is performed.

The different illustrative embodiments recognize that it is desirable to send messages 224 back to the group, organization, team, or other suitable entity that supports the application producing messages 224. Returning messages 224 allows for changes to be made to avoid further failures. Failure queue 226 also includes error log 228. This error log includes error information as to why messages 224 have failed to be sent.

Failed message process 222 accesses message 234 and creates message table 230. Message table 230 may be a temporary message table used to group messages into grouped messages 232. Failed message process 222 may obtain message 234 from messages 224 for processing.

Message 234 includes header 236 and body 238. Header 236 may contain information used to route and/or process message 234. Body 238 may contain data for the particular message. This data may include, for example, a sales transaction, an order, a response to an inquiry, or some other suitable information. Header 236 includes message identifier 240 and associated field pairs 242.

Failed message process 222 examines header 236 to message 234. Failed message process 222 uses message identifier 240 to determine whether this message has been previously processed. If message identifier 240 is not present in message table 230, the process checks one or more of associated field pairs 242 against entries within message table 230. In these examples, failed message process 222 examines associated field pairs 242 to message 234.

Associated field pairs 242 may be any pair of fields within header 236 that may be used to group message 234 into grouped messages 232. Failed message process 222 determines whether an associated field pair within associated field pairs 242 matches an entry within message table 230. If a match is not present, message 234 is added as a new entry to message table 230. If a match is present, then message 234 is added to the group in grouped messages 232 that generate a match. Messages 224 may be grouped within message table 230 using an indicator to identify the logical group of messages in grouped messages 232.

After messages 224 have been processed by failed message process 222, grouped messages 232 may be sent to a set of recipients. The set of recipients may be identified in a number of different ways. For example, the set of recipients may be identified using recipients database 244. Recipients database 244 may identify recipients based on the associated field pairs for grouped messages 232.

The illustration of different components within data processing system 200 in FIG. 2 is not meant to imply architectural limitations to a manner in which different illustrative embodiments may be implemented. For example, failure queue 226 is located in persistent storage 208 in data processing system 200. However, this failure queue may be located in other locations. For example, failure queue 226 may be located in a remote data processing system with failed message process 222 accessing messages 224 from that remote data processing system. As another example, in other illustrative embodiments, recipients database 244 may be located in persistent storage 208 rather than memory 206, depending on the particular implementation.

With reference now to FIG. 3, a diagram illustrating an entry in a message table is depicted in accordance with an illustrated embodiment. Entry 300 is an example of an entry within message table 230 used to form grouped messages 232 in FIG. 2. In this example, entry 300 includes message identifier 302, reply to queue 304, reply to queue manager 306, user identifier 308, put application name 310, and logical group identifier 312.

Message identifier 302 is a unique identifier for a message, such as message 234 in FIG. 2. Reply to queue 304 is a name of a message queue in which the application that issued a get request for the message sends a reply or report messages. Reply to queue manager 306 identifiers the local name of a queue for a queue manager.

In this example, reply to queue 304 and reply to queue manager 306 form an associated field pair. An associated field pair is a pair of associated identifier that may be used to identify recipients for messages that have failed to have been routed or sent. User identification 308 and put application name 310 are another example of an associated field pair that may be used to group the messages. Put application name 310 identifies the name of the application that “put” the message on a queue for transmission. This field may be part of the original context of the message. User identifier 308 may identify the user of the application that originated the message. Logical group identifier 312 is used to logically group messages that have matched an associated field pair for another entry within the table.

Entry 300 is generated for each message processed in these examples. As illustrated, associated field pair 314 is compared with a corresponding associated field pair, such as, associated field pairs 242 in FIG. 2, in the message to determine whether a match is present. If a match is not present by examining entries containing associated field pair 314, entries containing associated field pair 316 may then be compared with the corresponding associated field pairs in the message. If a match is not present after these two comparisons, a new entry similar to entry 300 may be generated with a new unique value for the logical group identifier. If a match is present, then a new entry is created in which logical group identifier 312 may have a value of the logical group identifier of the matching entry.

Although two pairs of associated field pairs are compared in this example, other illustrative embodiments may employ other numbers of associated field pairs. For example, one or three associated field pairs may be checked in these examples.

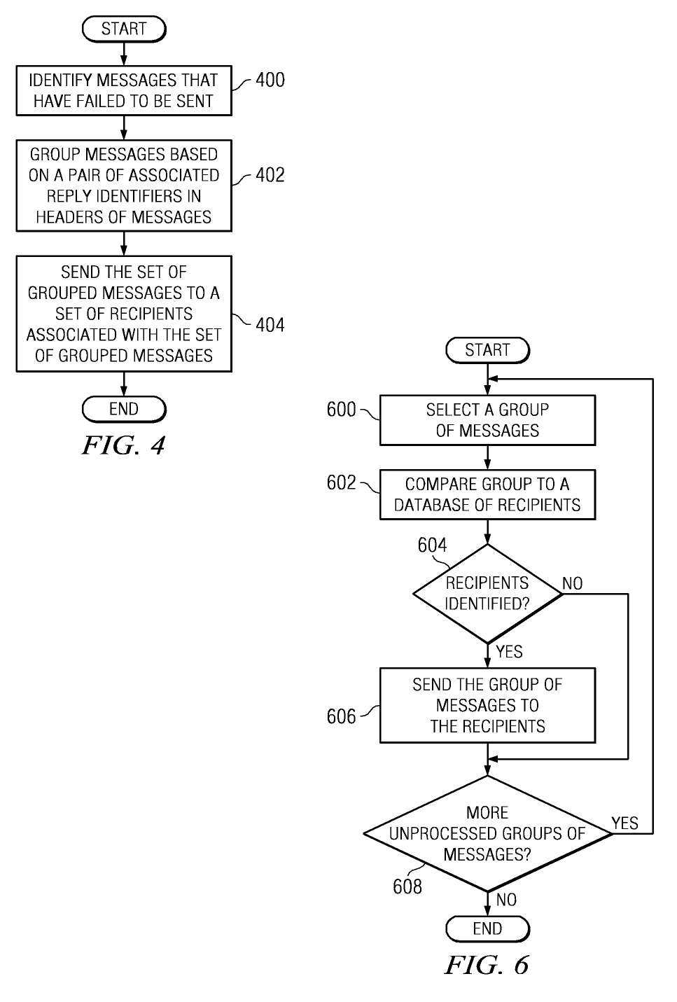

With reference now to FIG. 4, a flowchart of a process for grouping messages is depicted in accordance with an illustrative embodiment. The failed message process illustrated in FIG. 4 may be implemented in a software component, such as, failed message process 222 in FIG. 2.

The failed message process begins with a failed message process identifying messages that have failed to be sent (step 400). This step may include identifying a failure queue with messages for processing. The failed message process then groups messages based on a pair of associated reply identifiers in headers of the messages to form a set of grouped messages (step 402). The failed message process then sends the set of grouped messages to a set of recipients associated with the set of grouped messages (step 404), with the process terminating thereafter.

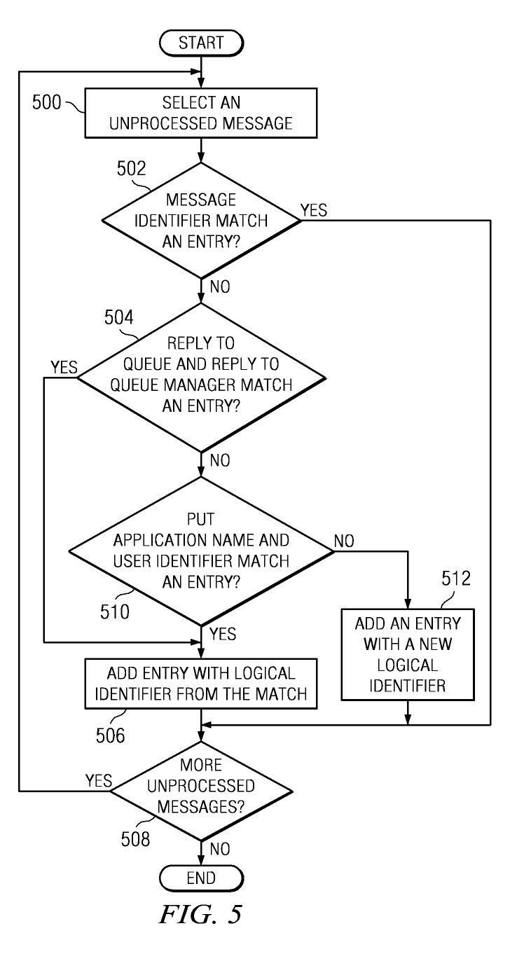

With reference now to FIG. 5, a flowchart of a process for grouping messages is depicted in accordance with an illustrative embodiment. The failed message process illustrated in FIG. 5 is a more detailed example of one implementation of step 402 in FIG. 4.

The failed message process begins with the failed message process selecting an unprocessed message for processing (step 500). The failed message process then determines whether the message identifier in the message matches an entry in the table (step 502). If a match is not present, the failed message process determines whether the reply to the queue and the reply to the queue manager in the header match an entry (step 504). If a match is present, the failed message process adds an entry to the table for the message with a logical identifier from the entry in the table that matches the message (step 506). Thereafter, the failed message process determines whether more unprocessed messages are present for processing (step 508). If additional unprocessed messages are not present, the process terminates. Otherwise, the fail message process returns to step 500 to select another unprocessed message.

With reference again to step 504, if the reply to the queue and the reply to the queue manager do not match an entry, the failed message process determines whether the put application name and the user identifier in the message match an entry in the table (step 510). If a match is present, the failed message process proceeds to step 506 as described above. Otherwise, the failed message process adds an entry with a new logical identifier (step 512). A new logical identifier is used because the associated field pair process does not match any entries in the table.

The failed message process then proceeds to step 508 as described above. With reference again to step 502, if the message identifier matches an entry, the failed message process proceeds to step 508 as described above.

With reference now to FIG. 6, a flowchart of a process for sending groups of messages to recipients is depicted in accordance with an illustrative embodiment. The process illustrated in FIG. 6 is a more detailed illustration of one implementation of step 404 in FIG. 4.

The failed message process begins with the failed message process selecting a group of messages (step 600). In step 600, the failed message process may select a representative message from the entries for processing. The failed message process compares the group to a database of recipients (step 602). This comparison involves determining whether many of the associated field pairs match a recipient in the database. The failed message process determines whether a recipient has been identified (step 604).

If a recipient has been identified, the failed message process sends the group of messages to the recipient (step 606). In step 606, the failed message process may send the representative message, all of the messages in a group, or some portion of the messages in the group. In other illustrative examples, the failed message process may just send the entries in the table. Additionally, error information from error log 228 in FIG. 2 also may be appended and sent to the recipients for use in analyzing why the message could not be transformed and/or routed to the appropriate destination.

The failed message process determines whether more unprocessed groups of messages are present (step 608). If more unprocessed groups of messages are present, the process returns to step 600. Otherwise, the process terminates. With reference again to step 604, if a recipient is not identified, the process proceeds to step 608 as described above. In some instances, messages may remain without a recipient. These messages may be processed using currently available techniques.

Thus, the different illustrative embodiments provide a computer implemented method, apparatus, and computer usable program code for handling messages. Messages that have failed to be sent to a set of destination applications are identified. These messages are grouped based on a pair of associated identifiers in the headers for the messages into a set of groupings. The set of groupings is sent to a pair of associated identifiers in the headers for the messages into a set of groupings. The set of groupings is sent to a set of recipients associated with the set of groupings.

The different illustrative embodiments provide a capability to process messages that have failed to have been sent in an automated manner without requiring user intervention. The different processes illustrated above may be initiated on a periodic basis or based on some event. In this manner, time and cost in handling messages may be reduced.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for handling messages, the computer implemented method comprising:
identifying a plurality of messages that have failed to be sent to a set of destination applications;
grouping the plurality of messages based on a pair of associated identifiers in headers for the plurality of messages into a set of groupings; and
sending the set of groupings to a set of recipients associated with the set of groupings.

2. The computer implemented method of claim 1, wherein the set of recipients originate the plurality of messages.

3. The computer implemented method of claim 1 further comprising:
identifying a recipient for each grouping in the set of groupings using the pair of associated identifiers to form the set of recipients.

4. The computer implemented method of claim 1, wherein the pair of associated identifiers comprises a first identifier of a message queue for a message handling program to which a response message is to be sent and a second identifier of an owner of the message queue.

5. The computer implemented method of claim 1, wherein the sending step comprises:
sending a representative message from the each grouping to the set of recipients.

6. The computer implemented method of claim 1, wherein a selected grouping in the set of groupings comprises the messages in which the pair of associated identifiers contains insufficient information to be grouped based on the pair of associated identifiers and further comprising:
grouping the messages using a second pair of associated identifiers in the headers.

7. The computer implemented method of claim 6, wherein the second pair of associated identifiers comprises a user identifier and a put application name.

8. The computer implemented method of claim 1, wherein a recipient in the set of recipients is selected from one of a person, a group of persons, an organization, and an application.

9. A data processing system comprising:
a bus;
a communications unit connected to the bus;
a storage device connected to the bus, wherein the storage device includes program code; and
a processor unit connected to the bus, wherein the processor unit executes the program code to identify a plurality of messages that have failed to be sent to a set of destination applications; group the plurality of messages based on a pair of associated identifiers in headers for the plurality of messages into a set of groupings; and send the set of groupings to a set of recipients associated with the set of groupings.

10. The data processing system of claim 9, wherein the set of recipients originate the plurality of messages.

11. The data processing system of claim 9, wherein the processor unit further executes the program code to identify a recipient for each grouping in the set of groupings using the pair of associated identifiers to form the set of recipients.

12. The data processing system of claim 9, wherein the pair of associated identifiers comprises a first identifier of a message queue for a message handling program to which a response message is to be sent and a second identifier of an owner of the message queue.

13. The data processing system of claim 9, wherein in executing the program code to send the set of groupings to the set of recipients associated with the set of groupings, the processor unit executes the program code to send a representative message from the each grouping to the set of recipients.

14. The data processing system of claim 9, wherein a selected grouping in the set of groupings comprises the messages in which the pair of associated identifiers contains insufficient information to be grouped based on the pair of associated identifiers and wherein the processor unit further executes the program code to group the messages using a second pair of associated identifiers in the headers.

15. The data processing system of claim 14, wherein the second pair of associated identifiers comprises a user identifier and a put application name.

16. The data processing system of claim 9, wherein a recipient in the set of recipients is selected from one of a person, a group of persons, an organization, and an application.

17. A computer program product comprising for handling messages, the computer program product comprising:
a computer readable medium;
program code, stored on the computer recordable storage medium, for identifying a plurality of messages that have failed to be sent to a set of destination applications;
program code, stored on the computer recordable storage medium, for grouping the plurality of messages based on a pair of associated identifiers in headers for the plurality of messages into a set of groupings; and
program code, stored on the computer recordable storage medium, for sending the set of groupings to a set of recipients associated with the set of groupings.

18. The computer program product of claim 17, wherein the set of recipients originate the plurality of messages.

19. The computer program product of claim 17 further comprising:
program code, stored on the computer recordable storage medium, for identifying a recipient for each grouping in the set of groupings using the pair of associated identifiers to form the set of recipients.

20. The computer program product of claim 17, wherein the pair of associated identifiers comprises a first identifier of a message queue for a message handling program to which a response message is to be sent and a second identifier of an owner of the message queue.
